(19) United States
(12) Patent Application Publication
(10) Pub. No.: US 2008/0131865 A1
(43) Pub. Date: Jun. 5, 2008

(54) Instructional cubes and composite structures therefrom

(76) Inventor: James Ernest, Kerrville, TX (US)

Correspondence Address: Christopher J. Whewell;Western Patent Group, 6020 Tonkowa Trail, Georgetown, TX, 78628, US

(21) Appl. No.: 11/977,992

(22) Filed: Oct. 27, 2007

Related U.S. Application Data
(60) Provisional application No. 60/872,884, filed on Dec. 5, 2006.

(51) Int. Cl. G09B 23/04

(52) U.S. Cl. 434/403; 434/211; 434/96

(57) ABSTRACT

Provided are cubes from which composite structures may be produced. Composite structures constructed from a plurality of cubes according to the invention are useful as an instructional aid to students for enabling them to readily visualize front perspective, end perspective, and overhead perspective views of complex geometrical shapes. Visualization of such perspective views enables students to more readily produce drawings of such perspective views in paper renditions of such views, and exercises the three-dimensional thinking centers of the brain.

### CROSS-REFERENCE TO RELATED APPLICATIONS

This application claims the benefit of U.S. Provisional Application No. 60/872,884 filed Dec. 5, 2006, the entire contents of each of which are herein incorporated by reference.

### TECHNICAL FIELD

This invention relates generally to instructional aids for use by teachers and students. More particularly, it relates to cubic structures which may be combined with one another to provide composite structures, which enable students to readily cognize frontal, overhead, and end perspective views of such composite structures.

### BACKGROUND

Orthographic projections are used often by engineers in designing various articles which are to be manufactured, in many classes of subject matter. Early on in the education of engineers and other personnel involved with constructively reducing mental conceptions to practice, one comes upon the use of orthographic projections, for example in one or more courses on drafting, or mechanical drawing. The human mind is easily capable of conceptualizing two-dimensional and one-dimensional concepts; however, conceptualizing three-dimensional objects provides added challenges to the mind, especially for young students in the age range of between about 10 and 16. In a typical classroom setting in which discussions are geared towards the teaching goal of reducing a three-dimensional object to frontal, overhead, and end view perspectives, or vice versa, students often have difficulties visualizing exactly how the aforementioned perspective views should appear on paper. To date, the most beneficent means of teaching students such visualizations is by repeated trial and error, drilling, and practice. If a means were available which could readily enable students to more quickly conceptualize such perspective views, such a teaching aid would be welcomed by both students and teachers alike.

### SUMMARY OF THE INVENTION

The invention provides a six-sided cube useful as an instructional aid. In one embodiment, a cube comprises a first set of three faces having an intersection at a first apex point and a second set of three faces having an intersection at a second apex point. The first and second apex points are disposed at opposite corners of the cube, and each of the faces of the first set of three faces are each distinguishable from one another in visual appearance, and each of the faces of the second set of three faces are not distinguishable from one another in visual appearance. Also provided are composite structures which are comprised of a plurality of the cubes.

### BRIEF DESCRIPTION OF THE DRAWINGS

In the annexed drawings:

FIG. 1 shows a perspective view of a composite structure composed of cubes according to the prior art;

FIG. 2 shows an overhead view of the composite structure of FIG. 1;

FIG. 3 shows a frontal view of the composite structure of FIG. 1;

FIG. 4 shows an end view of the composite structure of FIG. 1;

FIG. 5 shows a perspective view of a cube structure;

FIG. 6 shows a frontal perspective view of a cube according to one embodiment of the invention;

FIG. 7 shows a rear perspective view of a cube according to one embodiment of the invention;

FIG. 8 shows a perspective view of a composite structure composed of cubes according to one embodiment of the invention;

FIG. 9 shows a frontal view of the composite structure of FIG. 8;

FIG. 10 shows an overhead view of the composite structure of FIG. 8; and

FIG. 11 shows an end view of the composite structure of FIG. 8.

### DETAILED DESCRIPTION

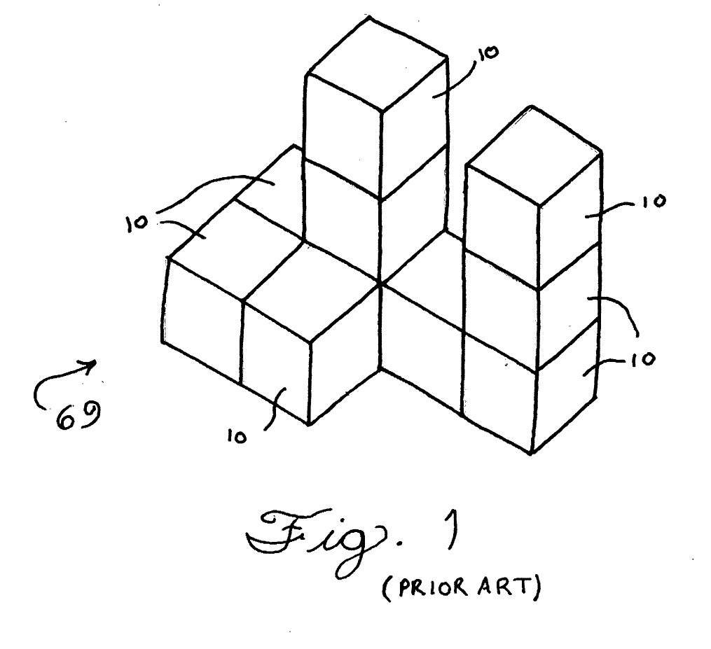

Referring to the drawings and initially to FIG. 1 there is shown a perspective view of a composite structure 69 composed of cubes 10 according to the prior art. Such a composite structure is useful as a learning aid for students in developing and enhancing cognitive abilities as a result of their being requested to construct frontal, overhead, and end perspective views on paper drawings of such a composite structure 69 and vice versa. The composite structure 69 of FIG. 1 may be assembled from a plurality of cubes 10, each of which may be comprised of a wide variety of materials, including without limitation: metals and metallic alloys; wood; fiberglass; cardboard; paper; polymers; composite materials; and reinforced composite materials. Any composite structure as described herein may be produced by stacking individual cubes atop one another so that the composite structure may be readily de-constructed at will. Alternatively, the individual cubes which comprise a composite structure described herein may be affixed to one another by conventional fastening means, such as welding, adhesives and glues, snaps, and hook-and-loop type fasteners, including VELCRO® fasteners disposed on the faces of the cubes.

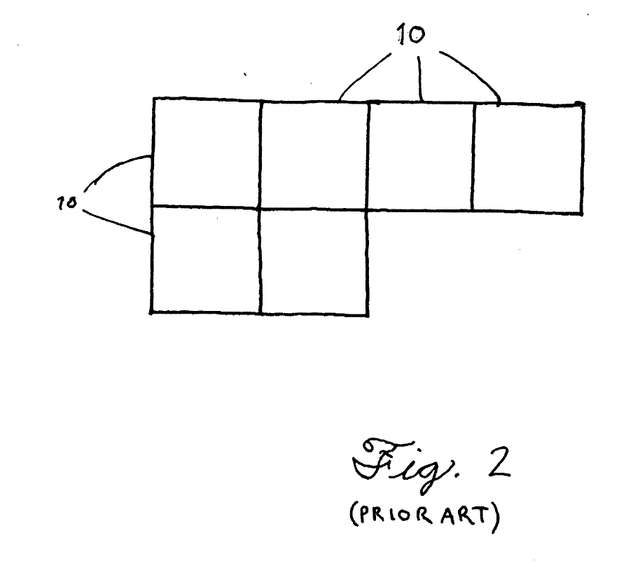

In FIG. 2 is shown an overhead view of the composite structure of FIG. 1, which a student would be expected to construct on paper after observing the three-dimensional composite structure of FIG. 1. In this overhead view, each cube 10 is represented in such two-dimensional rendering by a square.

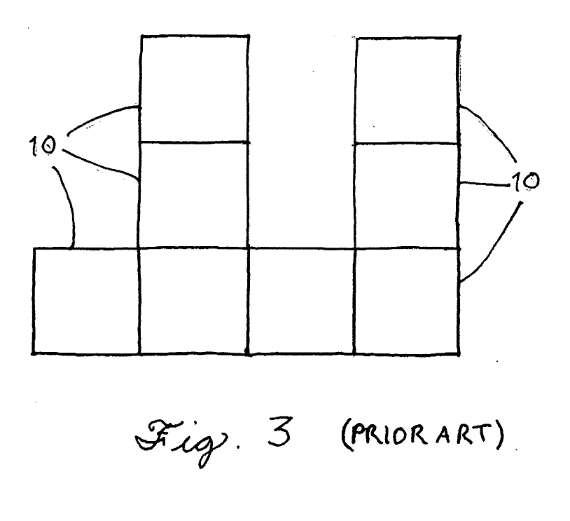

In FIG. 3 is shown a frontal view of the composite structure of FIG. 1, which a student would be expected to construct on paper after observing the three-dimensional composite structure of FIG. 1. In this frontal view, each cube 10 is represented in such two-dimensional rendering by a square.

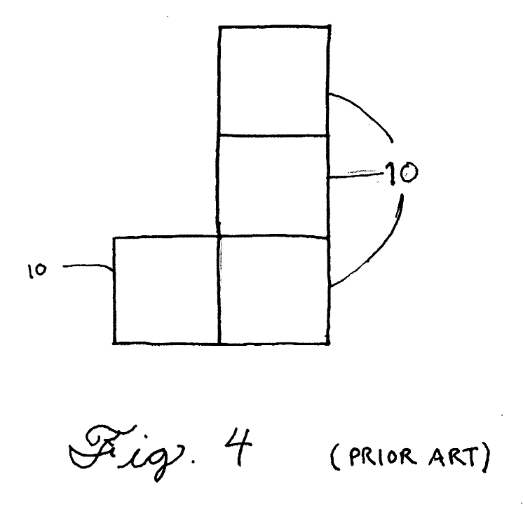

In FIG. 4 is shown an end view of the composite structure of FIG. 1, which a student would be expected to construct on paper after observing the three-dimensional composite structure of FIG. 1. In this end view, each cube 10 is represented in such two-dimensional rendering by a square.

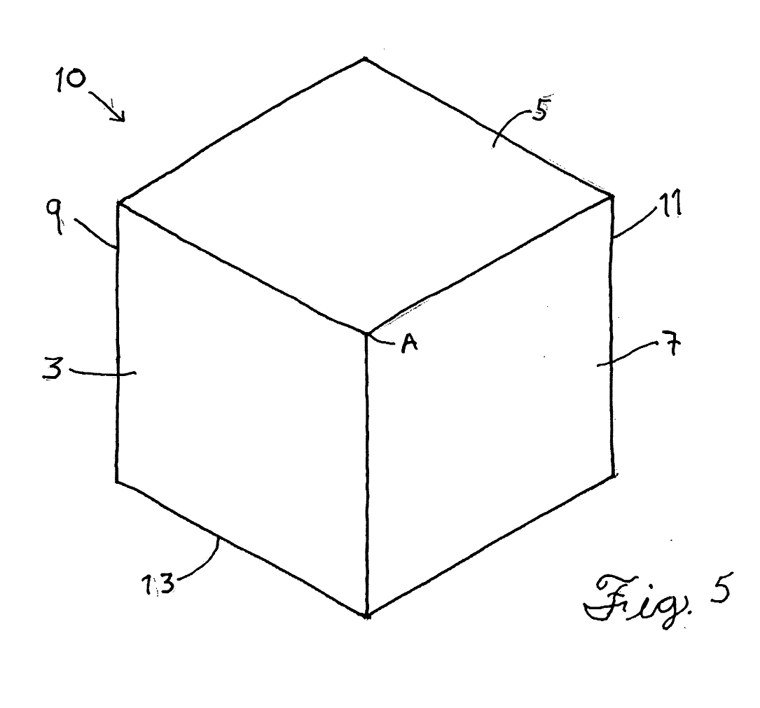

In FIG. 5 is shown a perspective view of a cube 10. As with all solid cubes, cube 10 comprises six faces, which for convenience sake herein may be referred to as a front face 3, a top face 5, a right-side face 7, a left-side face 9, a rear face 11, and a bottom face 13. There is an apex point A, which is a point corresponding substantially to a corner of the cube at which three of the faces intersect, such as the front face 3, top face 5, and right-side face 7 in FIG. 5.

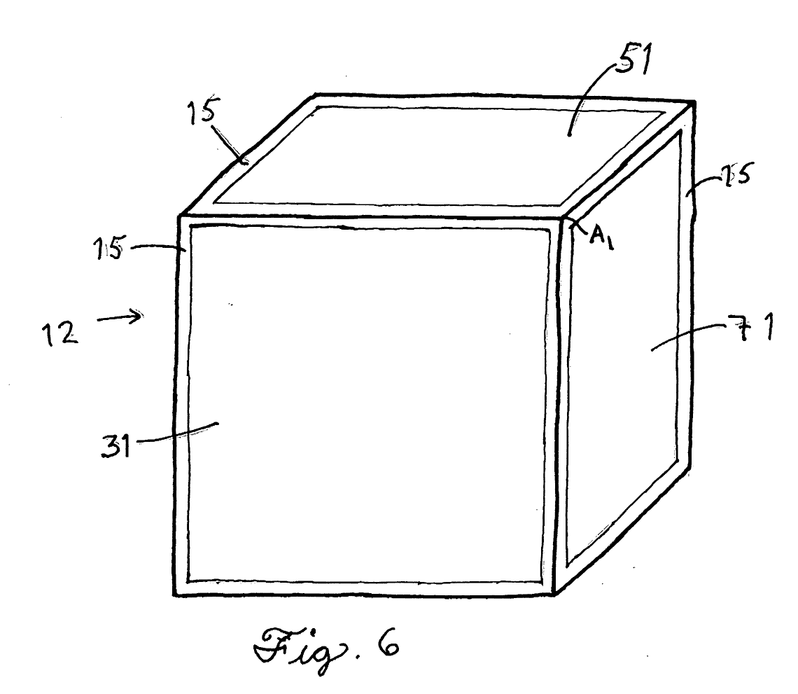

FIG. 6 shows a frontal perspective view of a cube 12 according to one embodiment of the invention. In this embodiment, the cube 12 comprises six faces, including a front face 31, a top face 51 and a right-side face 71. There is also an apex point A₁ at which the front face 31, top face 51 and right-side face 71 intersect. In a preferred embodiment, the front face 31, top face 51 and right-side face 71 are each colored, tinted, shaded, textured, or otherwise comprise features on their surfaces which permits each of these surfaces to be readily distinguished visibly from one another upon casual observance by a person within visual proximity of the cube. Visibly distinguishable means that a person can detect a difference in appearance of two separate surfaces using their eyes. Essentially, any difference in light-reflecting properties on the faces may accomplish the desired effect of rendering the faces visibly distinguishable from one another. One face may be rough in texture, another comprising a shiny surface such as a mirror, polished aluminum, etc., while a third is painted black, for example, all of which have different light-reflecting properties. Any difference in light-reflecting properties of the faces which produces a visually-observable difference is a suitable scheme for use within the principles of the invention. In one non-limiting example, in one embodiment, the top face 51 may be colored black, the front face 31 may be colored blue, and the right-side face 71 may be colored red. Thus, any one of each of the three front face 31, top face 51 and right-side face 71 may comprise any color, shade, tint or other distinguishing feature with respect to the remaining two faces. Such colors, shades, and tints thereof include without limitation all primary and secondary colors, and all blends and mixtures thereof, such as red, blue, yellow, green, violet, orange, pink, black, white and any and all shades of the foregoing. Coloration may be provided on any of the faces of the cube by conventional means, such as through the use of dyes, inks, paints, pigments and other known materials useful for imparting colors to a surface, including decals and stickers, transfers, and the like, as such are known in the art. In one instance in which the pertinent faces of a cube 12 according to one embodiment comprise different textures, such cube 12 and composite structures comprised of a plurality of such cubes 12 may be useful by the visually-impaired, since differences in textures can be discerned by the touch sensation.

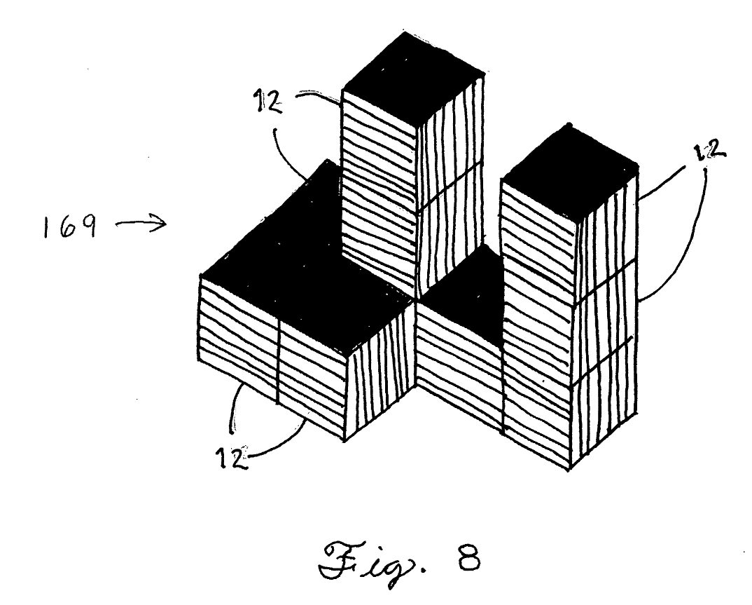

In one preferred embodiment, there is a border 15 disposed between the outer perimeter of a given face on the cube, and the region which is colored, shaded, tinted, textured, etc., to be visually distinguishable from the remaining faces. Each face on the cube comprises four edges, which define a closed perimeter on a particular face. The border 15 region is disposed adjacent to the perimeter that is defined by the faces, as shown in FIGS. 8, 9, 10, 11. Thus, the border defines the interior region within the closed perimeter defined by the four edges of a face on the cube, i.e., the interior region is completely bounded by the border region. In one embodiment the border 15 has a width of any width in the range of between about one millimeter and twenty-five millimeters, including all ranges of widths therebetween. In a preferred embodiment the border 15 had a width of any width in the range of between about one millimeter and ten millimeters. In one embodiment the front face 31 of the cube 12 in FIG. 6 may be blue and the blue face is bounded on all four sides by a border 15, which is of a different color than the blue face, for example, the border 15 is white in color. However, the border may comprise any color, shade, tint, texture, etc., which is visibly noticeably different from the visual appearance of the much larger region on the cube face that is interior to the border 15. Hence, the border may be colored using any coloration or visual differentiation that contrasts with the visual appearance of the region interior to the border 15, including without limitation all primary and secondary colors and all blends and mixtures thereof, also including black and white and all shades thereof. In a preferred embodiment the visual appearance of the border 15 that is disposed about any one of the front face 31, top face 51 and right-side face 71 is identical in appearance to the border 15 disposed on both of the remaining two of these three faces. In a another embodiment, the visual appearance of the border 15 that is disposed about any one of the front face 31, top face 51 and right-side face 71 is different in appearance to the border 15 disposed on one or both of the remaining two of these three faces.

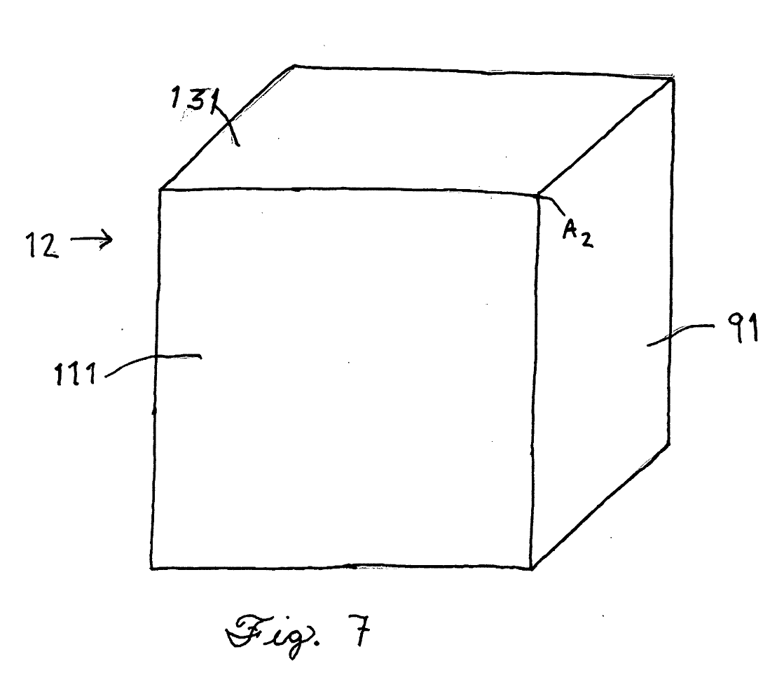

In FIG. 7 is shown a rear perspective view of the cube 12 depicted in FIG. 6, flipped upside-down to more clearly show the bottom face 131, according to one embodiment of the invention. Thus, the respective locations of the rear face 111, left side face 91 and bottom face 131 are shown, as well as the apex point A2 at which each of the rear face 111, left side face 91 and bottom face 131 intersect. The apex A2 is disposed at the corner on the cube 12 that is opposite to the apex point Al. In one embodiment, none of the rear face 111, left side face 91 and bottom face 131 are colored or caused to take on any special visual scheme. In one embodiment, at least two of the rear face 111, left side face 91 and bottom face 131 are all the same color, or are otherwise identical in visual appearance, with respect to one another. In another embodiment, the rear face 111, left side face 91 and bottom face 131 are colored in the same scheme as was earlier described for the front face 31, top face 51 and right-side face 71. In one embodiment, the visual appearance of the rear face 111, left side face 91 and bottom face 131 may each independently be the same as the appearance of any one or more of the front face 31, top face 51 and right-side face 71. In another embodiment, the visual appearance of the rear face 111, left side face 91 and bottom face 131 may each independently be different from the appearance of any one or more of the front face 31, top face 51 and right-side face 71. In one embodiment, none of the rear face 111, left side face 91 and bottom face 131 comprise a border, analogous to border 15, but rather are of uniform coloration across their entire faces. In one embodiment, all three of the rear face 111, left side face 91 and bottom face 131 are identical in visual appearance with respect to one another. In one embodiment, the rear face 111, left side face 91 and bottom face 131 are all black. In one embodiment, the rear face 111, left side face 91 and bottom face 131 are all white. In one embodiment, the rear face 111, left side face 91 and bottom face 131 are all grey.

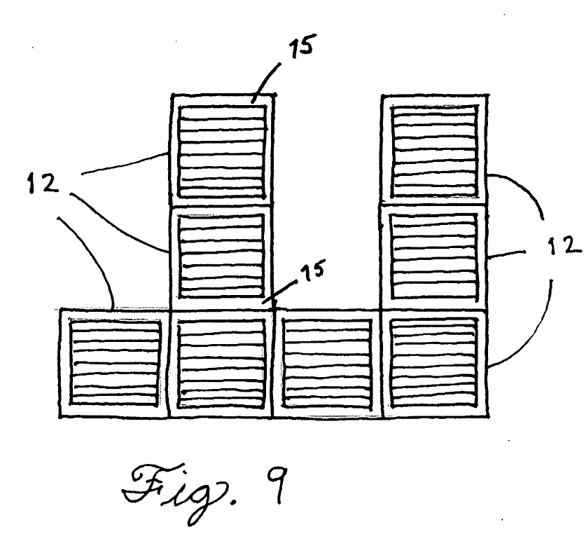

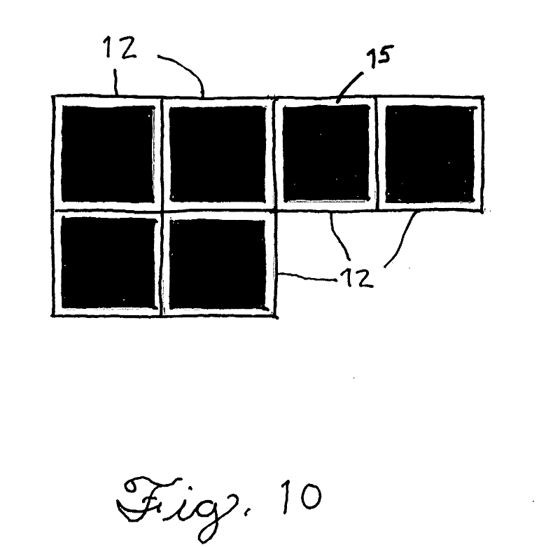

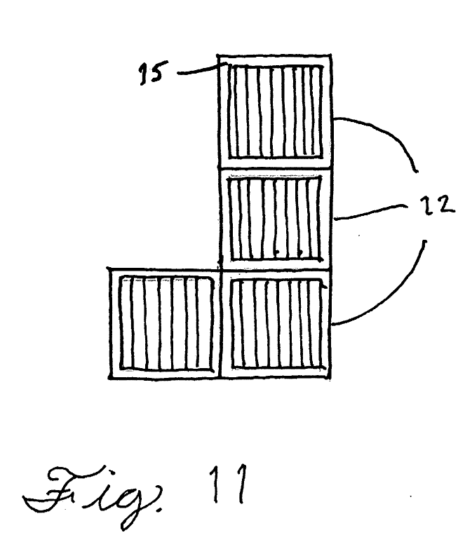

In FIG. 8 is shown a perspective view of a composite structure 169 composed of a plurality of cubes 12 according to one embodiment of the invention. In the embodiment shown in FIG. 8 the cubes 12 are provided and arranged with their front faces being colored blue, their right side faces being colored red, and their top faces being colored black.. Such an arrangement enables the frontal view of the composite 169 to appear completely blue, as an aid in teaching students to readily visualize a frontal view of such a structure as more clearly shown in FIG. 9. The optional border 15 provides additional beneficial color contrast. The arrangement of the colored faces of the cubes 12 in FIG. 8 also simultaneously provides for the top view of the composite 169 to appear completely black, also as an aid in teaching students to readily visualize a top view of such a structure as more clearly shown in FIG. 10. The arrangement of the colored faces of the cubes 12 in FIG. 8 also simultaneously provides for the end view of the composite 169 to appear completely red, also as an aid in teaching students to readily visualize an end view of such a structure as more clearly shown in FIG. 11.

Thus, during use of a plurality of cubes 12 according to the invention to provide a composite structure, by stacking the cubes, fastening the cubes together, etc. to the desires of a user, the coloration of the front faces 31, top faces 51 and right-side faces 71 of each cube employed is preferably such that the cubes 12 may be oriented to provide uniform visual appearance to each of the frontal, top, and end views of such composite structure as an aid in learning, particularly to students in the sixth, seventh, and eighth grade levels.

Although the use of a plurality of cubes 12 according to the principles of the present invention as described herein has been illustrated with respect to a particular structure, namely that shown in FIG. 8, it is readily appreciated by one of ordinary skill that a plurality of cubes 12 according to the invention may be employed to construct thousands, in fact, millions of possible structures, being limited only by the number of cubes 12 available and the imagination of the artisan. The various transfigurations of the individual pieces, as well as all known combinations thereof of the well-known SOMA puzzle of Piet Hein of course fall within such class, as illustrative.

Consideration must be given to the fact that although this invention has been described and disclosed in relation to certain preferred embodiments, obvious equivalent modifications and alterations thereof will become apparent to one of ordinary skill in this art upon reading and understanding this specification and the claims appended hereto. This includes subject matter defined by any combination of any one of the various claims appended hereto with any one or more of the remaining claims, including the incorporation of the features and/or limitations of any dependent claim, singly or in combination with features and/or limitations of any one or more of the other dependent claims, with features and/or limitations of any one or more of the independent claims, with the remaining dependent claims in their original text being read and applied to any independent claims so modified. This also includes combination of the features and/or limitations of one or more of the independent claims with features and/or limitations of another independent claims to arrive at a modified independent claim, with the remaining dependent claims in their original text being read and applied to any independent claim so modified. Accordingly, the presently disclosed invention is intended to cover all such modifications and alterations, and is limited only by the scope of the claims which follow.

What is claimed is:

1) A six-sided cube useful as an instructional aid, said cube comprising a first set of three faces having an intersection at a first apex point and a second set of three faces having an intersection at a second apex point, said first and second apex points being disposed at opposite corners of said cube, wherein each of the faces of said first set of three faces are each distinguishable from one another in visual appearance, and wherein each of the faces of said second set of three faces are not distinguishable from one another in visual appearance.

2) A cube according to claim 1 wherein the faces of each of said first set of three faces each comprise:
a) four edges which define a closed perimeter on each face;
b) a border region disposed adjacent to said perimeter defined by said faces; and
c) an interior region within said border region, wherein said border region is distinguishable in visible appearance from said interior region.

3) A cube according to claim 2 wherein said interior region is completely bounded by said border region.

4) A cube according to claim 1 wherein said faces of each of said first set of three faces are visibly distinguishable by virtue of their each comprising a different coloration.

5) A cube according to claim 1 wherein said faces of each of said first set of three faces are visibly distinguishable by virtue of their each comprising a different surface texture.

6) A cube according to claim 1 wherein said faces of each of said first set of three faces are visibly distinguishable by virtue of their each comprising different light-reflecting properties.

7) A cube according to claim 1 wherein said first set of three faces comprises a first face, a second face, and a third face, wherein each of said first face, said second face, and said third face of said first set of three faces each independently comprise a color selected from the group consisting of: red, blue, yellow, orange, green, violet, pink, black, and white, including all shades and hues thereof.

8) A cube according to claim 1 wherein said first set of three faces comprises a first face, a second face, and a third face, wherein said first face comprises the color red, said second face comprises the color blue, and said third face comprises the color black.

9) A cube according to claim 2 wherein said border region has a width dimension within the range of between about one millimeter and ten millimeters.

10) A cube according to claim 2 wherein said border region comprises a color selected from the group consisting of: red, blue, yellow, orange, green, violet, pink, black, and white.

11) A cube according to claim 1 wherein said second set of three faces comprises a first face, a second face, and a third face, wherein each of said first face, said second face, and said third face of said second set of three faces each collectively comprise the same color selected from the group consisting of: red, blue, yellow, orange, green, violet, pink, black, and white.

12) A cube according to claim 1 wherein the three faces which are within said second set of three faces are visibly-distinguishable from each and every one of the faces within said first set of three faces.

13) A composite structure that comprises a plurality of cubes, said cubes each comprising a first set of three faces having an intersection at a first apex point and a second set of three faces having an intersection at a second apex point, said first and second apex points being disposed at opposite corners of said cubes, wherein each of the faces of said first set of three faces on each cube are each distinguishable from one another in visual appearance, and wherein each of the faces of said second set of three faces on each cube are not distinguishable from one another in visual appearance.
